(19) United States
(12) Patent Application Publication
(10) Pub. No.: US 2024/0205383 A1
(43) Pub. Date: Jun. 20, 2024

(54) VIEWING ANGLE CONTROL MEMBER AND DISPLAY DEVICE INCLUDING THE SAME

(71) Applicant: LG Display Co., Ltd., Seoul (KR)

(72) Inventors: Semin LEE, Paju-si (KR); Seungju GWON, Paju-si (KR); Jaejung HAN, Paju-si (KR)

(21) Appl. No.: 18/524,964

(22) Filed: Nov. 30, 2023

(30) Foreign Application Priority Data
Dec. 19, 2022 (KR) 10-2022-0178145

(51) Int. Cl. H04N 13/349; H04N 13/305; H04N 13/398

(52) U.S. Cl. CPC H04N 13/349; H04N 13/305; H04N 13/398

(57) ABSTRACT

A viewing angle control member according to an embodiment includes a substrate and a plurality of lens patterns arranged on the substrate, wherein the lens patterns have a generally trapezoidal shape with rounded sidewalls.

### CROSS REFERENCE TO RELATED APPLICATION

The present application claims priority to Korean Patent Application No. 10-2022-0178145, filed Dec. 19, 2022, the entire contents of which is incorporated herein for all purposes by this reference.

### BACKGROUND

### Technical Field

The present disclosure relates to a viewing angle control member and a display device including the same.

### Description of the Related Art

Dimming films, attached to the front of display panels in devices such as mobile phones, laptops, tablet personal computers (PCs), car navigation systems, and touchscreens in cars, block light transmitted from the light source and adjust the optical viewing angle according to the incident angle of the light to provide users with clear image quality for users at the desired viewing angle when the display transmits the screen image.

Dimming films can also be used on windows of vehicles or buildings to partially block external light to prevent glare or to make the inside of a space not visible from outside.

That is, a dimming film can be an optical path transforming material that controls the direction of light by blocking light in certain directions and allowing light to pass through in specific directions. Therefore, by controlling the angle of light transmission through dimming films, it is possible to control the user's viewing angle.

### BRIEF SUMMARY

It is an object of the present disclosure to provide a viewing angle control member capable of facilitating viewing angle control and enhancing brightness ratio while reducing manufacturing cost and simplifying manufacturing process.

It is another object of the present disclosure to provide a display device including a viewing angle control member capable of facilitating viewing angle control and enhancing brightness ratio while reducing manufacturing cost and simplifying manufacturing process.

The objects of the present disclosure are not limited to the aforesaid, and other objects not described herein with be clearly understood by those skilled in the art from the descriptions below.

In order to accomplish the above objects, a viewing angle control member according to an embodiment includes a substrate and a plurality of lens patterns arranged on the substrate, wherein the lens patterns have has a generally trapezoidal shape with rounded sidewalls from the bottom to the top.

In order to accomplish the above objects, a viewing angle control member according to another embodiment includes a substrate and a plurality of lens patterns arranged on the substrate, wherein the lens patterns have a generally triangular shape with rounded sidewalls.

In order to accomplish the above objects, a display device according to an embodiment includes a display panel, a viewing angle control member arranged beneath a bottom surface of the display panel, and an adhesive member bonding the display panel and viewing angle control member, wherein the viewing angle control member includes a substrate and a plurality of lens patterns arranged on the substrate and having a refractive index greater than that of the adhesive member.

In order to accomplish the above objects, a display device according to another embodiment includes a display panel and a viewing angle control member arranged on a top surface of the display panel, wherein the viewing angle control member includes a substrate and a plurality of lens patterns arranged on the substrate and having a generally trapezoidal shape with a flat bottom surface, a flat top surface and rounded sidewalls extending in an arc shape from the bottom surface to the top surface. It can also be a generally triangular shape with a flat bottom surface, and rounded sidewalls extending in an arc shape from the bottom surface to the top portion of the triangle.

The detailed descriptions of other embodiments are included in the specifications and drawings.

The viewing angle control member and display device according to the embodiments are advantageous in terms of facilitating viewing angle control and enhancing brightness ratio while reducing manufacturing cost and simplifying manufacturing process.

The advantages according to the embodiments are not limited to the aforesaid, and a variety of other advantages are included within the specification.

### BRIEF DESCRIPTION OF THE SEVERAL VIEWS OF THE DRAWINGS

FIG. 1 is a plan view of a display device according to an embodiment;

FIG. 2 is a cross-sectional view taken along line I-I′ of FIG. 1;

FIG. 3 is a plan view of a viewing angle control member according to an embodiment;

FIG. 4 is a cross-sectional view taken along line II-II′ of FIG. 3;

FIG. 5 is an enlarged cross-sectional view of a lens pattern of FIG. 4;

FIG. 6 is a schematic diagram for explaining the effect of a viewing angle control member according to an embodiment;

FIGS. 7 and 8 are graphs showing the transmittance as a function of angle for different substrate thicknesses in an embodiment;

FIG. 9 is a diagram illustrating an original equipment manufacturer (OEM) brightness coordinate system;

FIG. 10 is a plan view of a viewing angle control member according to another embodiment;

FIG. 11 is a plan view of a viewing angle control member according to another embodiment;

FIG. 12 is a cross-sectional view of a viewing angle control member according to another embodiment;

FIG. 13 is a cross-sectional view of a viewing angle control member according to another embodiment;

FIG. 14 is a cross-sectional view of a viewing angle control member according to another embodiment;

FIG. 15 is a cross-sectional view of a viewing angle control member according to another embodiment;

FIG. 16 is a cross-sectional view of a viewing angle control member according to another embodiment;

FIG. 17 is a cross-sectional view of a display device according to another embodiment;

FIG. 18 is a cross-sectional view of the viewing angle control member and display panel of FIG. 17; and

FIG. 19 is a cross-sectional view of a display device according to another embodiment.

### DETAILED DESCRIPTION

Advantages and features of the present disclosure and methods of accomplishing the same may be understood more readily by reference to the following detailed description of embodiments and the accompanying drawings. The disclosed disclosure may, however, be embodied in many different forms and should not be construed as being limited to the exemplary embodiments set forth herein; rather, these exemplary embodiments are provided so that this disclosure will be thorough and complete and will fully convey the concept of the disclosure to those skilled in the art.

When it is mentioned that one device or layer is located on another device or layer, it may be understood that one device or layer is directly located on the other device or layer or that still other device or layer is interposed between the two devices or layers. Throughout the specification, the same reference numerals refer to the same components. The shapes, sizes, ratios, angles, numbers and the like disclosed in the drawings to describe embodiments of the present disclosure are merely exemplary, and thus, the present disclosure is not limited thereto.

Although the terms “first,” “second,” and the like are used for describing various components, these components are not confined by these terms. These terms are merely used for distinguishing one component from the other components. Accordingly, a first component mentioned earlier may also be a second component within the technical spirit of the present disclosure.

The various features of the embodiments of the present disclosure can combined or assembled together, either partially or entirely, in a technically diverse manner, and each embodiment can be independently implemented or in conjunction with related embodiments.

Hereinafter, exemplary embodiments of the present disclosure will be described in detail with reference to accompanying drawings.

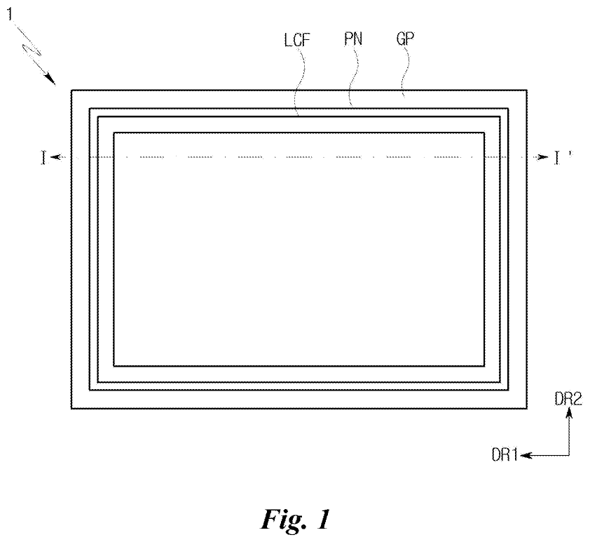

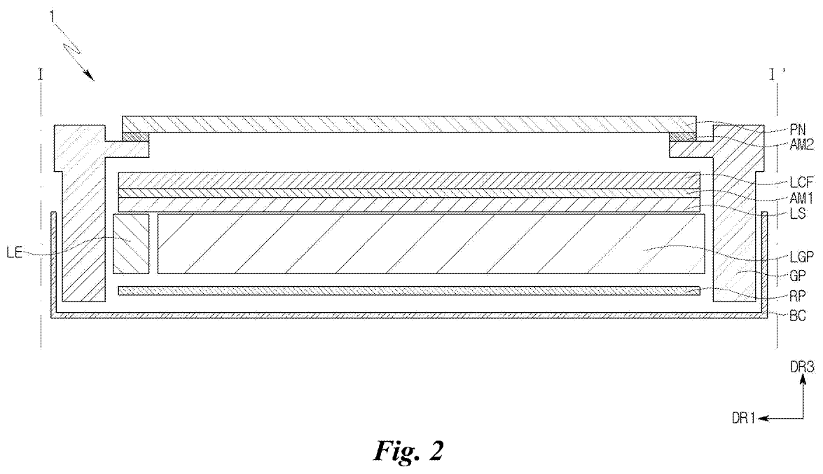

FIG. 1 is a plan view of a display device according to an embodiment; FIG. 2 is a cross-sectional view taken along line I-I′ of FIG. 1;

With reference to FIGS. 1 and 2, the display device 1 according to an embodiment may refer to any electronic device that provides a display screen. Examples of the display device 1 may include mobile phones, smartphones, tablet PCs, electronic watches, smartwatches, watch phones, mobile communication terminals, electronic notebooks, electronic books (e-books), Portable Multimedia Players (PMPs), navigation devices, game consoles, digital cameras, televisions, laptops, monitors, advertising displays, and Internet of Things (IOT) devices that are equipped with a display screen. For example, the display device 1 according to an embodiment may be, but not limited to, a display device for a vehicle.

The display device 1 may have a rectangular shape including elongated sides extended in a first direction DR1 and shorter sides extended in a second direction DR2. The corners where the elongated sides and shorter sides meet may be angular, but they are not limited to such and may have a curved shape. Without being limited to these examples, the planar shape of the display device 1 may also be a square, circular, elliptical, or other polygonal shape.

The display device 1 may include a display area and a non-display area surrounding the display area. The display area may include a plurality of pixels and be capable of generating an image. Meanwhile, the non-display area may not generate an image, but is not limited thereto.

The display device 1 may include a display panel PN and a viewing angle control member LCF that overlaps with the display panel PN. A viewing angle control member LCF can function to control the viewing angle of an incident light. The planar shape of the display panel PN may be similar or identical to the planar shape of the display device 1. The planar shape of the viewing angle control member LCF may be similar to or identical to the planar shape of the display panel PN. A guide panel GP may be disposed around the outer periphery of the display panel PN. The guide panel GP can serve to support the display panel PN in order for the display panel PN to be arranged. The guide panel GP may overlap with the outer edge of the display panel PN.

As shown in FIG. 2, the display device 1 may include a back cover BC, a reflection member RP, a backlight unit LGP and LE, a light-sheet LS, a first adhesive member AM1, a viewing angle control member LCF, a second adhesive member AM2, and a display panel PN.

The back cover BC may be placed on the outside of the display device 1. The back cover BC may be placed under the backlight unit LGP and LE to completely cover the planar guide panel GP, the backlight unit LGP and LE, display panel PN, and the viewing angle control member LCF. The back cover BC may also be placed on the side of the guide panel GP.

The second adhesive member AM2 may be interposed between the guide panel GP and the display panel PN. As described above, the guide panel GP may be disposed under the display panel PN to support the display panel PN by being placed on the outside of the peripheral portion of the display panel PN. The second adhesive member AM2 is not limited as long as capable of coupling the display panel PN and the guide panel GP.

The display panel PN may be a liquid crystal display panel. The display panel PN may receive light emitted from the backlight unit LGP and LE and may emit specific colors in each emitting area through color filters in the display area.

The reflection member RP may be disposed between the back cover BC and the backlight unit LGP and LE. The reflection member RP may be positioned beneath the backlight unit LGP and LE to reflect light emitted from the light emitting device LE and directed download in the light guide plate LGP in an upward direction. To achieve this, the reflection member RP may include metals or other materials with high reflectivity.

The backlight unit LGP and LE may be disposed above the reflection member RP. The backlight unit LGP and LE may include the light emitting device LE and a light guide plate LGP disposed adjacent to the light emitting device LE. The light emitting device LE may be arranged on one side of the light guide plate LGP. Therefore, the backlight unit LGP and LE according to this embodiment may be an edge-lit type backlight unit in which the light emitting device LE is disposed on one side of the light guide plate LGP. However, without being limited thereto, the light emitting device LE may be disposed beneath the backlight unit LGP and LE to form a direct-lit type backlight unit. When a direct-lit type backlight unit is used, the reflection member RP may be omitted.

An light-sheet LS may be disposed on the backlight unit LGP and LE. The light-sheet LS may include a diffusion sheet or the like that diffuses light emitted in the upward direction from the light guide plate LGP. Since the optical sheet LS is widely known in the art, detailed description thereof will be omitted.

The viewing angle control member LCF may be disposed on the light-sheet LS. The first adhesive member AM1 may be disposed between the light-sheet LS and the viewing angle control member LCF. The first adhesive member AM1 may include a bonding material with high light transmittance to allow light from the light guide plate LGP in the upward direction to pass through to the display panel PN. For example, the first adhesive member AM1 may include, but not limited to, an optically transparent adhesive OCA or an optically transparent resin OCR.

The viewing angle control member LCF may control the viewing angle of light from the backlight unit LGP and LE.

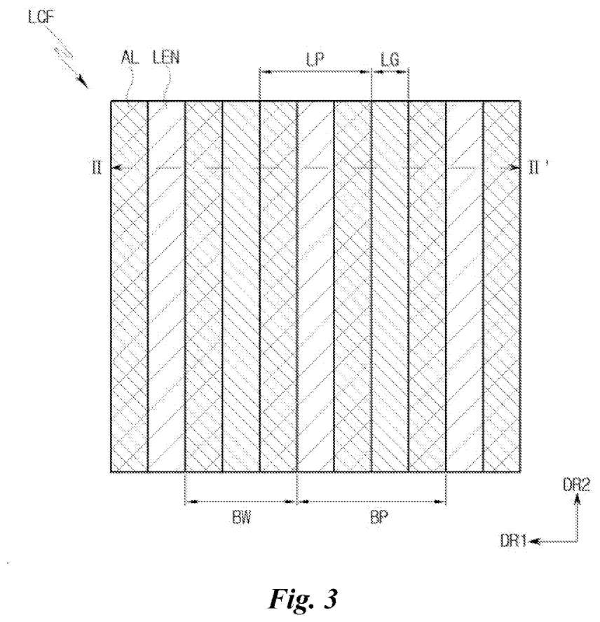

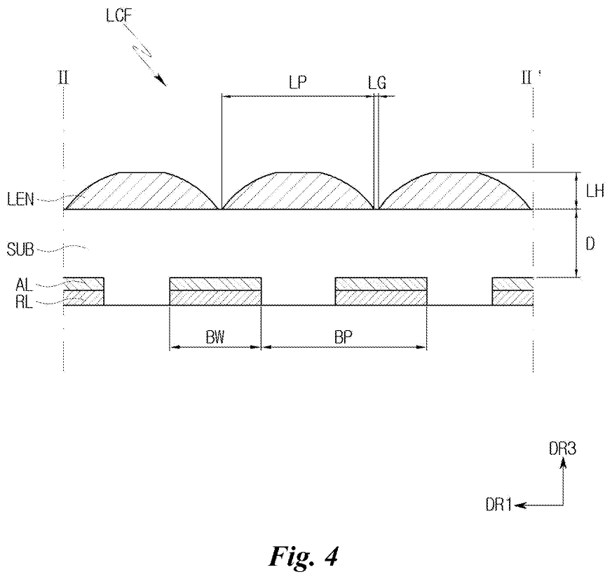

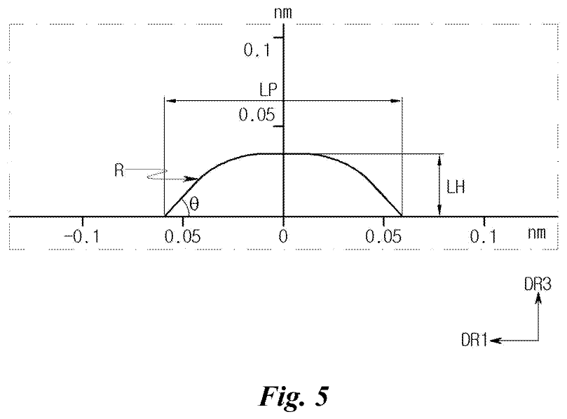

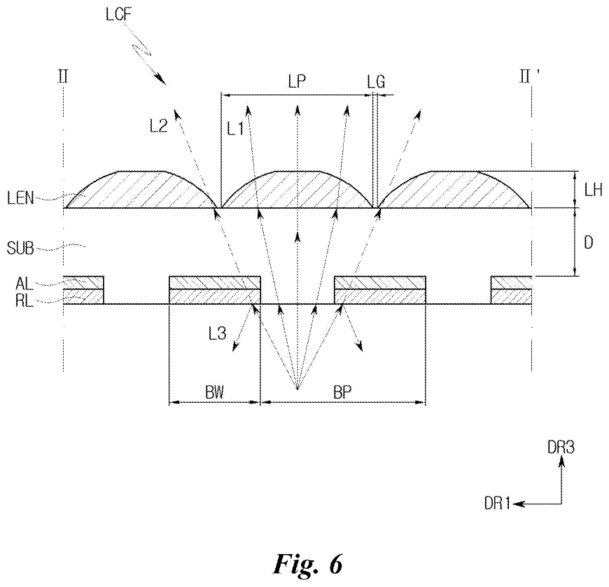

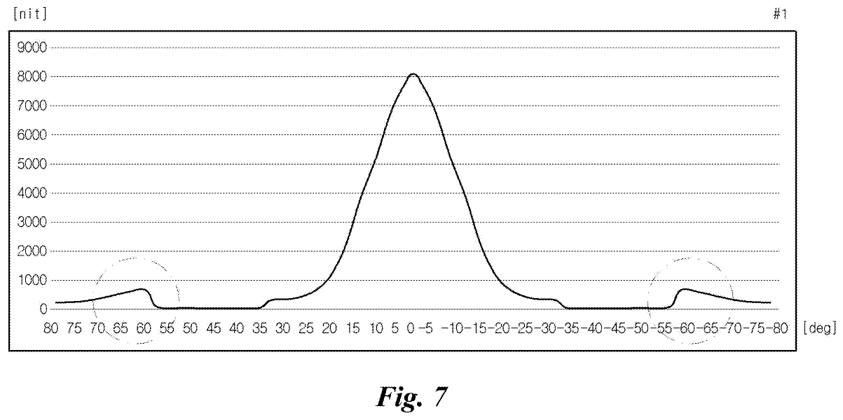

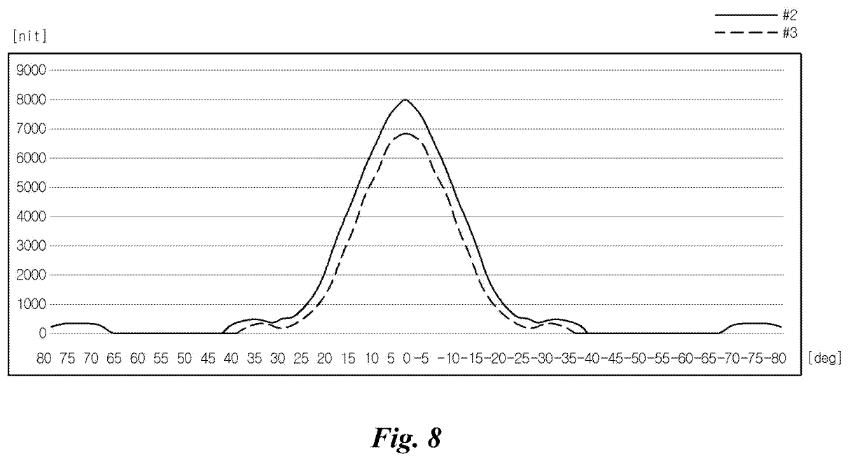

FIG. 3 is a plan view of a viewing angle control member according to an embodiment. FIG. 4 is a cross-sectional view taken along line II-II′ of FIG. 3. FIG. 5 is an enlarged cross-sectional view of a lens pattern of FIG. 4. FIG. 6 is a schematic diagram for explaining the effect of a viewing angle control member according to an embodiment. FIGS. 7 and 8 are graphs showing the transmittance as a function of angle for different substrate thicknesses in an embodiment. FIG. 9 is a diagram illustrating an original equipment manufacturer (OEM) brightness coordinate system.

First, with reference to FIGS. 3 and 4, the viewing angle control member LCF according to one embodiment may include a lens pattern LEN extended along a second direction DR2 and a lower layered structure extended along the second direction DR2. The lens pattern LEN and the lower layered structure may be provided in plurality and arranged with a distance along the first direction DR1, respectively.

The lens pattern LEN may have a generally trapezoidal shape in cross-section with rounded sidewalls. The lens pattern LEN may a trapezoidal shape in cross-section, with a constant slope of the taper from the bottom to the top, but may have rounded sidewalls instead. Thus, the shape is called generally trapezoidal since it has only two sides parallel to each other and the other two sides, which might be called legs, are not parallel to each other. As shown in FIG. 5, the sides, namely the legs, have an inclination angle θ of the lens pattern LEN may be 30° to 70°, relative to the base and the radius of curvature R of the sidewalls of the lens pattern LEN may be 1 mm or less.

While the lens is generally trapezoidal shape in cross-section as a 2D view, it is a 3D object, and thus if considered as an object it will be in the shape of any one of a truncated cone, a truncated sphere, truncated half sphere, or a truncated pyramid, each of which have rounded, namely curving sidewalls from the top the bottom.

The lens pattern LEN may have a first width LP, and adjacent lens patterns LEN may be spaced apart by a first separation distance LG. The lens pattern LEN may have a first thickness LH.

The lower layered structure may include a reflective layer RL and an absorptive layer AL on the reflective layer RL as shown in FIG. 4. The reflective layer RL and the absorptive layer AL may overlap each other in the thickness direction. The reflective layer RL and the absorptive layer AL may be equal in width, but without being limited thereto. The reflective layer RL may serve to reflect light from the outside. The reflectance of the reflective layer RL for light from the outside may be about 20%. The reflective layer RL may be a specular layer that specularly reflects light from the outside. The absorptive layer AL may serve to absorb light from the outside. The transmittance of the absorptive layer AL for light from the outside may be about 10% or less.

The lower layered structure may have a second width BW and may be arranged along the first direction DR1 with a first pitch BP. Adjacent lower-layered structures may be spaced apart and arranged in the first direction DR1.

The viewing angle control member LCF may further include a substrate SUB on which the lens pattern LEN and the underlying layered structure are arranged. The substrate SUB may be made of a material including, but is not limited to, plastics or glass.

The lower layered structure may be arranged on the bottom surface of the substrate SUB, and the lens patterns LEN may be arranged on the top surface of the substrate SUB. The substrate SUB may have a second thickness D.

The lens patterns LEN may be arranged directly on the top surface of the substrate SUB. The lower layered structure may be arranged directly on the bottom surface of the substrate SUB.

For example, as shown in FIG. 4, the substrate SUB may include grooves recessed upward from the bottom, and the lower layered structures may be respectively arranged in the recessed grooves. The absorptive layer AL of the lower layered structure may be directly disposed within the recessed grooves on the bottom surface of the substrate SUB. The second thickness D may be equal to the distance from the lower layered structures to the top surface of the substrate SUB. The thickness of the substrate SUB in areas where the recessed grooves are not present may be greater than the second thickness D.

The lower layered structures may overlap with the spacing between adjacent lens patterns LEN in the thickness direction. That is, the lower layered structures may be arranged between adjacent lens patterns LEN.

As shown in FIG. 6, the reflective layer RL may serve to specularly reflect back light from outside (or from below) (see L3). The absorptive layer AL may serve to absorb light passing through the reflective layer RL or light directly incident impinged on the reflective layer RL (see L2). Light L1 incident upward between adjacent lower layered structures may pass through the substrate SUB and be incident upon the lens pattern LEN. The lens patterns LEN may be directly in contact, on their bottom surface, with the substrate SUB and, on their top surface, with air. Light L1 incident upon the lens patterns LEN from the substrate SUB may be refracted at the interface toward the center of the lens pattern LEN due to the difference in refractive index between the substrate SUB and the lens pattern LEN and then refracted, when exiting the lens pattern LEN into air, again toward the center of the lens pattern LEN due to the difference in refractive index between the lens pattern LEN and the air. To ensure that the light L1 incident upon the lens patterns LEN from the substrate SUB is refracted toward the center of the lens pattern LEN at the interface and then refracted again, when exiting the lens pattern LEN into air, toward the center of the lens pattern LEN due to the difference in refractive index between the lens pattern LEN and the air, the lens pattern LEN may have a refractive index of approximately 1.4 to 2.0, while the substrate SUB may have a refractive index of approximately 1.45 to 1.7.

As described above, the lens patterns LEN have a first width LP and are spaced apart from each other by the first separation distance LG, and the plurality of lower layered structures have the second width BW and are arranged with the first pitch BP, wherein the sum of the first width LP and the first separation distance LG may be equal to the first pitch BP.

The first width LP may be 0.8 to 1 times the first pitch BP.

The first separation distance LG may be 0 to 0.2 times the first pitch BP.

The lens patterns LEN have the first thickness LH of 0.05 to 0.5 times the first pitch BP.

The substrate SUB has the second thickness D, which may be 0.7 to 1.3 times the first pitch.

The second width BW may be 0.2 to 0.7 times the first pitch BP.

As described above, the viewing angle control member LCF according to an embodiment may effectively control the side viewing angle and also effectively increase the frontal luminance by refracting the light incident on the lens patterns LEN through the adjacent lower layered structures to the center of the lens patterns LEN. For this purpose, the first width LP may be 0.8 to 1 times the first pitch BP, the first separation distance LG may be 0 to 0.2 times the first pitch BP, the lens patterns LEN may have the first thickness LH of 0.05 to 0.5 times the first pitch BP, the substrate SUB may have the second thickness, the second thickness D may be 0.7 to 1.3 times the first pitch BP, the second width BW may be 0.2 to 0.7 times the first pitch BP, the inclination angle θ of the lens patterns LEN may be 30° to 70°, and the radius of curvature R of the sidewalls of the lens patterns LEN may be 1 mm or less.

With reference to FIGS. 7 and 8, one embodiment (hereinafter, #1) represented in FIG. 7 shows the brightness (nit) of light with a viewing angle (deg) looking at the display device when the second thickness D is greater than 1.3 times the first pitch BP. #1 may be an example of application of a lens pattern LEN of a generally trapezoidal shape with rounded sidewalls according to an embodiment. Embodiments (hereinafter, #2 and #3) represented in FIG. 8 respectively show the brightness (nit) of light with a viewing angle (deg) looking at the display device when the second thickness D is equal to or less than 1.3 times the first pitch BP. In particular, the lens pattern of #3 may be an embodiment in which a conventional lenticular-shaped lens pattern is applied, and #2 may be an embodiment in which a lens pattern LEN of a trapezoidal shape with rounded sidewalls is applied according to an embodiment. That is, in the embodiment of #2, the inclination angle θ of the lens pattern LEN may be 30° to 70°, and the radius of curvature R of the sidewalls of the lens pattern LEN may be 1 mm or less.

As shown in FIG. 7, when the second thickness D is greater than 1.3 times the first pitch BP, it was confirmed that the brightness (nit) of light sharply increases at a viewing angle of 60° or more looking at the display device, reaching about 600 nit. This means that there is poor control of the side viewing angle and light leakage when the viewing angle of the display device is 60° or more.

On the other hand, as shown in FIG. 8, in the case of #2 and #3 where the second thickness D is equal to or less than 1.3 times the first pitch BP, it was confirmed that the brightness (nit) of light does not sharply increase at around 60° viewing angle when looking at the display device, and only in #2, it was confirmed that the brightness (nit) increases up to about 300 nit at around 65° viewing angle. That is, when the second thickness D is greater than 1.3 times the first pitch BP, light leakage does not occur up to about 60° viewing angle when looking at the display device, and even in #2, the brightness (nit) increases only up to about 300 nit at around 65° viewing angle, so it was confirmed that the light leakage from the side was significantly reduced compared to #1.

Furthermore, in example #2 with the application of a lens pattern LEN of a trapezoidal shape with rounded sidewalls according to an embodiment, it was confirmed that the brightness (nit) at 0° viewing angle is about 1500 nit higher than in example #3 with a conventional circular-shaped lens pattern, indicating a significant improvement in the frontal luminance ratio.

The display device 1 should have a high frontal luminance ratio when viewed from the front, i.e., at 0°, but it is also desirable to have a high luminance ratio above a certain value in a certain range of angles close to the front for the user. The certain range of angles may vary depending on each area A1, A2, and A3 illustrated in FIG. 9. FIG. 9 shows the OEM coordinate system with the first area A1, the second area A2, and the third area A3. The first area A1 may have a viewing angle range of −10° to 10° on the X-axis (or horizontal axis) and −4° to 8° on the Y-axis (or vertical axis), the second area A2 may have a viewing angle range of −40° to 40° on the X-axis (or horizontal axis) and −10° to 20° on the Y-axis (or vertical axis), and the third area A3 may have a viewing angle range of −50° to 50° on the X-axis (or horizontal axis) and −10° to 20° on the Y-axis (or vertical axis).

In the case of the lens pattern LEN according to an embodiment, the first width LP may be 0.8 to 1 times the first pitch BP, the first separation distance LG may be 0 to 0.2 times the first pitch BP, the first thickness LH may be 0.05 to 0.5 times the first pitch BP, the second thickness D may be 0.7 to 1.3 times the first pitch BP, the second width BW may be 0.2 to 0.7 times the first pitch BP, the inclination angle θ of the lens pattern LEN may be 30° to 70°, and the curvature radius R of the sidewalls of the lens pattern LEN may be 1 mm or less, and as a result, the minimum luminance ratio between the second area A2 and the first area A1 may be approximately 55% or higher, and the minimum luminance ratio between the third area A3 and the first area A1 may be approximately 40% or higher. The viewing angle control member LCF according to an embodiment is capable of improving the brightness within the certain angle range that can be regarded as the frontal viewing angle range as well as at 0°.

Hereinafter, a description is made of the specifications (Spec) of each of the components LEN, SUB, AL, and RL of the viewing angle control member LCF in detail.

According to an embodiment, ensuring the first width LP to be equal to or greater than 0.8 times the first pitch BP may secure the sufficient width of the lens pattern LEN, leading to the improvement of the frontal luminance ratio. In addition, ensuring the first distance LG to be 0 to 0.2 times the first pitch BP may secure the sufficient width of the lens pattern LEN, leading to the improvement of the frontal luminance ratio. Furthermore, ensuring the first thickness LH to be equal to or greater than 0.05 times the first pitch BP may make it possible for the lens pattern LEN to function as an optical component that refracts the light (L1 in FIG. 6) from the substrate SUB to the center of the lens pattern LEN, ensuring the first thickness LH to be equal to or less than 0.5 times the first pitch BP may make it possible to prevent a significant decrease in brightness within angle ranges of the second and third areas A2 and A3 excluding the first region A1 in FIG. 9, ensuring the second thickness D to be equal to or greater than 0.7 times the first pitch BP may make it possible to prevent a reduction in frontal transmittance, and ensuring the second thickness D to be equal to or less than 1.3 times the first pitch BP may make it possible to prevent the occurrence of light leakage due to poor control of the side viewing angle. In addition, ensuring the second width BW to be equal to or greater than 0.2 times the first pitch BP may make it possible to limit the side viewing angle within a certain range, and ensuring the second width BW to be equal to or less than 0.7 times the first pitch BP may make it possible to secure good frontal transmittance.

Hereinafter, description is made of the viewing angle control member according to another embodiment.

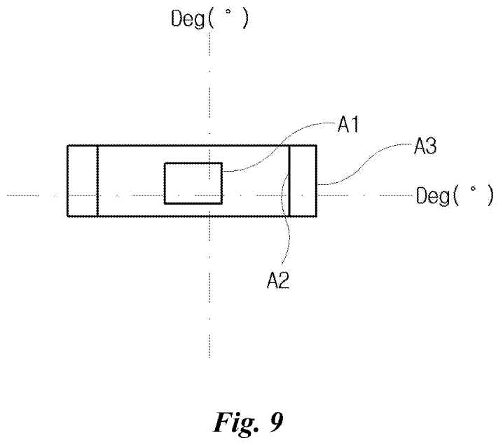

FIG. 10 is a plan view of a viewing angle control member according to another embodiment.

With reference to FIG. 10, the viewing angle control member LCF_1 according to this embodiment differs from the viewing angle control member (LCF) of FIG. 3 in that the lens patterns LEN_1 are arranged in an island array.

In more detail, the lens patterns LEN_1 of the viewing angle control member LCF_1 may be arranged in a mutual island array. The planar shape of each lens pattern (LEN_1) may be a rectangle or other polygonal shape. The lower layered structure (absorptive layer AL_1 is shown in FIG. 10) may be arranged between adjacent lens patterns LEN_1.

The additional description that has already been made with reference to FIG. 3 will be omitted.

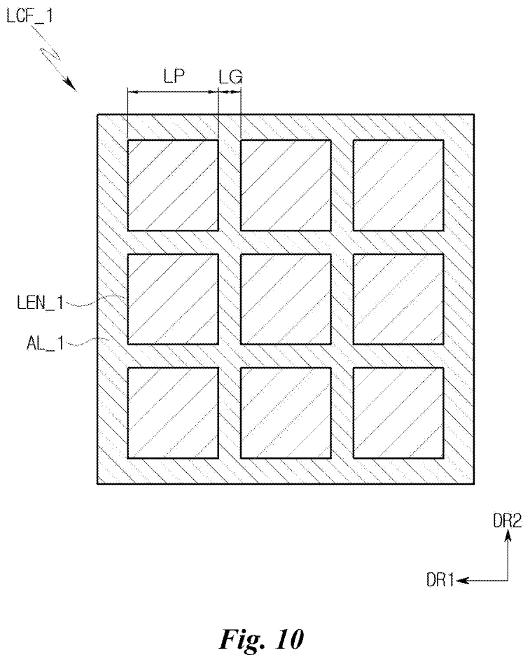

FIG. 11 is a plan view of a viewing angle control member according to another embodiment.

With reference to FIG. 11, the lens patterns LEN_2 of the viewing angle control member LCF_2 according to this embodiment differs from the lens patterns LEN_1 of FIG. 10 in that the planar shape is circular or elliptical.

The additional description that has already been made with reference to FIG. 10 will be omitted.

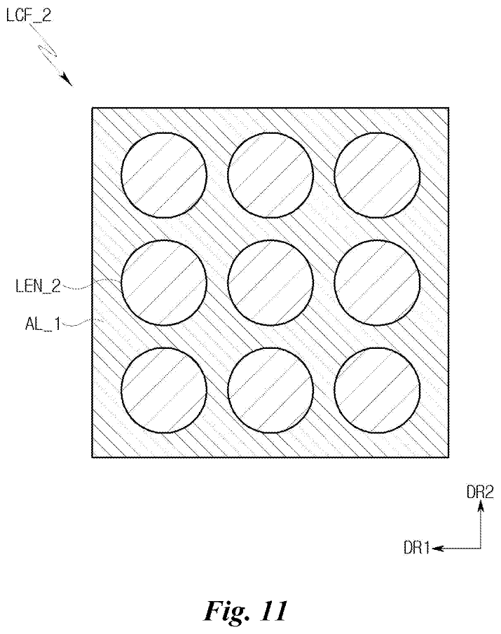

FIG. 12 is a cross-sectional view of a viewing angle control member according to another embodiment.

With reference to FIG. 12, the viewing angle control member LCF_3 according to this embodiment differs from the viewing angle control member LCF of FIG. 4 in that it further includes a lower lens layer BL disposed on the lower surface of the substrate SUB.

In more detail, the lower lens layer BL may be arranged between adjacent lower layered structures. The lower lens layer BL may be arranged directly on the bottom surface of the substrate SUB. The lower lens layer BL may have a higher refractive index than that of the substrate SUB. The difference in refractive index between the lower lens layer BL and the first adhesive member AM1 of FIG. 2 may be less than the difference in refractive index between the substrate SUB and the first adhesive member AM1 of FIG. 2. For example, the refractive index of the first adhesive member AM1 may be higher than that of the lower lens layer BL and the substrate SUB, respectively. In this embodiment, by placing the lower lens layer BL between the substrate SUB and the first adhesive member AM1, it is possible to minimize specular reflection of light passing through the first adhesive member AM1 at the interface between the substrate SUB and the first adhesive member AM1, thereby improving the front transmission rate.

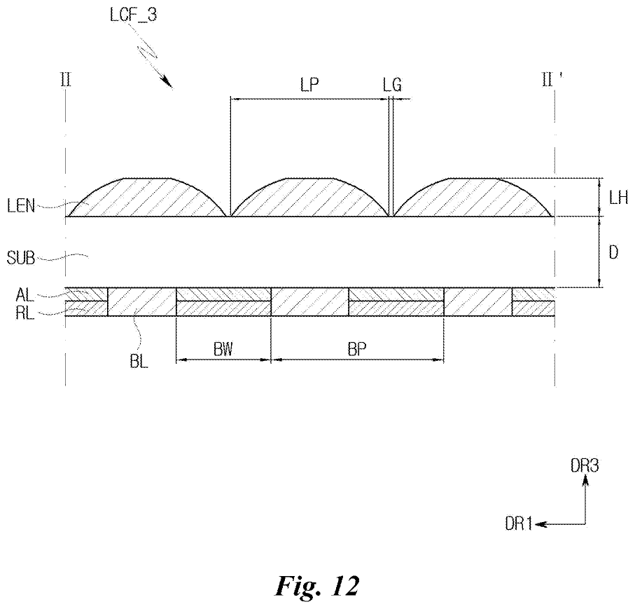

FIG. 13 is a cross-sectional view of a viewing angle control member according to another embodiment.

With reference to FIG. 13, the viewing angle control member LCF_4 according to this embodiment differs from the view angle control member LCF_3 of FIG. 12 in that it further includes a second lower lens layer BL_1 between the lower layered structure and the substrate SUB. The material of the lower lens layer BL_1 may be the same as that of the lower lens layer BL. The second lower lens layer BL_1 and the lower lens layer BL may be formed in an integrated manner. The bottom surface of the second lower lens layer BL_1 may directly contact the lower layered structure.

The additional description that has already been made with reference to FIG. 12 will be omitted.

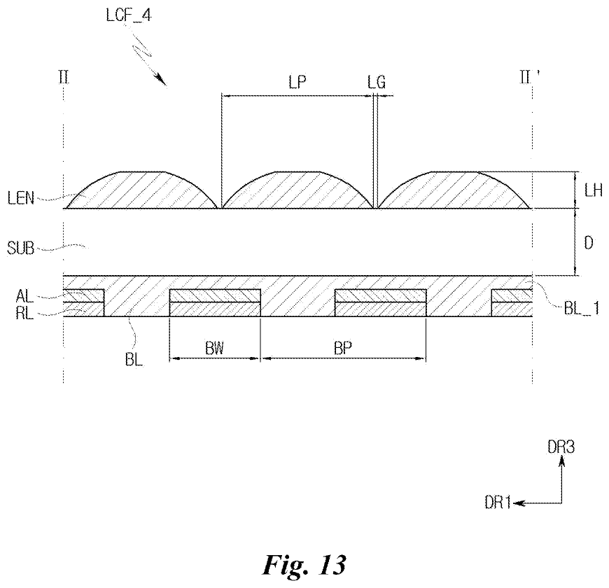

FIG. 14 is a cross-sectional view of a viewing angle control member according to another embodiment.

With reference to FIG. 14, the viewing angle control member LCF_5 according to this embodiment differs from the viewing angle control member LCF of FIG. 4 in that adjacent lens patterns LEN_3 are connected to each other.

The additional description that has already been made with reference to FIG. 4 will be omitted.

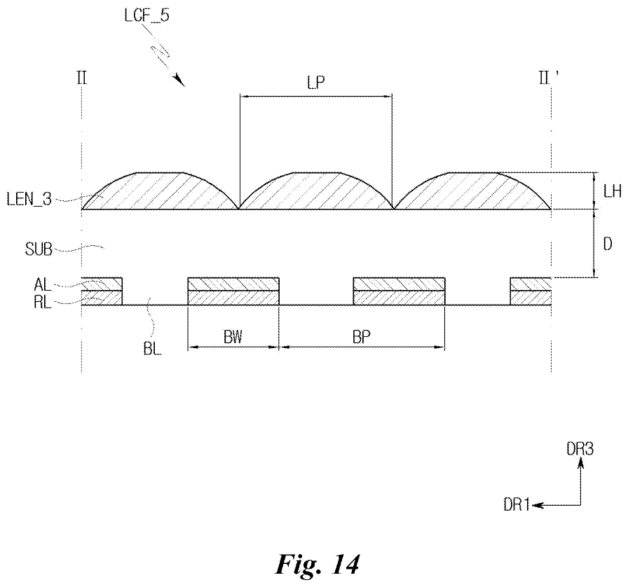

FIG. 15 is a cross-sectional view of a viewing angle control member according to another embodiment.

With reference to FIG. 15, the viewing angle control member LCF_6 according to this embodiment differs from the viewing angle control member LCF of FIG. 4 in that the lens patterns LEN_4 has a generally triangular shape with rounded sidewalls. Namely, the base of the triangle is on the substrate and the sidewalls extend in curved shape to the top region. The top region may have a slight curvature where the two sidewalls meet instead of point.

In more detail, the lens pattern (LEN_4) may have a generally triangular shape with rounded sidewalls. In this embodiment, the shape is not truncated.

The lens patterns LEN_4 may have a first width LP and be spaced apart from each other by the first separation distance LG, and the plurality of lower layered structures may have the second width BW and be arranged with the first pitch BP, wherein the sum of the first width LP and the first separation distance LG may be equal to the first pitch BP.

The first width LP may be 0.8 to 1 times the first pitch BP.

The first separation distance LG may be 0 to 0.2 times the first pitch BP.

The lens patterns LEN_4 may have the first thickness LH equal to or less than 0.4 times the first pitch BP.

The substrate SUB may have the second thickness D of 0.7 to 1.3 times the first pitch.

The second width BW may be 0.2 to 0.7 times the first pitch BP.

The lens patterns LEN_4 may have a slope angle between 5° and 50°, and the curvature radius R of the sidewalls of the lens patterns LEN_4 may be 1 mm or less.

As described above, the viewing angle control member LCF according to an embodiment may effectively control the side viewing angle and also effectively increase the frontal luminance by refracting the light incident on the lens patterns LEN_4 through the adjacent lower layered structures to the center of the lens patterns LEN_4. For this purpose, the first width LP may be 0.8 to 1 times the first pitch BP, the first separation distance LG may be 0 to 0.2 times the first pitch BP, the lens patterns LEN_4 may have the first thickness LH of 0.4 to 0.5 times the first pitch BP, the substrate SUB may have the second thickness, the second thickness D may be 0.7 to 1.3 times the first pitch BP, the second width BW may be 0.2 to 0.7 times the first pitch BP, the inclination angle θ of the lens patterns LEN_4 may be 5° to 50°, and the radius of curvature R of the sidewalls of the lens patterns LEN_4 may be 1 mm or less.

The display device should have a high frontal luminance ratio when viewed from the front, i.e., at 0°, but it is also desirable to have a high luminance ratio above a certain value in a certain range of angles close to the front for the user. The certain range of angles may vary depending on each area A1, A2, and A3 illustrated in FIG. 9.

According to this embodiment, ensuring the lens pattern LEN_4 to have the first width LP of 0.8 to 1 times the first pitch BP, the first separation distance LG of 0 to 0.2 times the first pitch BP, the first thickness LH of 0.4 times or less the first pitch BP, ensuring the substrate SUB to have the second thickness D of 0.7 to 1.3 times the first pitch BP, ensuring the second width BW to be 0.2 to 0.7 times the first pitch BP, ensuring the slope angle of the lens pattern LEN_4 to be 5° to 50°, and ensuring the curvature radius R of the sidewalls of the lens pattern LEN_4 to be 1 mm or less, may make it possible to achieve the ratio of the minimum luminance in the second area A2 to the minimum luminance in the first area A1 to be about 55% or more and the ratio of the minimum luminance in the third area A3 to the minimum luminance in the first area A1 to be about 38% or more. The viewing angle control member LCF_4 according to an embodiment is capable of improving the brightness within the certain angle range that can be regarded as the frontal viewing angle range as well as at 0°.

Hereinafter, a description is made of the specifications (Spec) of each of the components LEN_4, SUB, AL, and RL of the viewing angle control member LCF in detail.

According to an embodiment, ensuring the first width LP to be equal to or greater than 0.8 times the first pitch BP may make it possible to secure the sufficient width of the lens pattern LEN_4, leading to the improvement of the frontal luminance ratio. In addition, ensuring the first separation distance LG to be 0 to 0.2 times the first pitch BP may make it possible to secure the sufficient width of the lens pattern LEN_4, leading to the improvement of the frontal luminance ratio. In addition, ensuring the first thickness LH to be equal to or less than 0.4 times the first pitch BP may make it possible to prevent a significant decrease in luminance in the angle range of the second and third areas A2 and A3 excluding the first area A1, and ensuring the second thickness D to be equal to or greater than 0.7 times the first pitch BP may make it possible to prevent a decrease in frontal transmittance, and ensuring the second thickness D to be equal to or less than 1.3 times the first pitch BP may make it possible to prevent light leakage caused by poor control of the lateral viewing angle. In addition, ensuring the second width BW to be equal to or greater than 0.2 times the first pitch BP may make it possible to limit the side viewing angle within a certain range, and ensuring the second width BW to be equal to or less than 0.7 times the first pitch BP may secure good frontal transmittance.

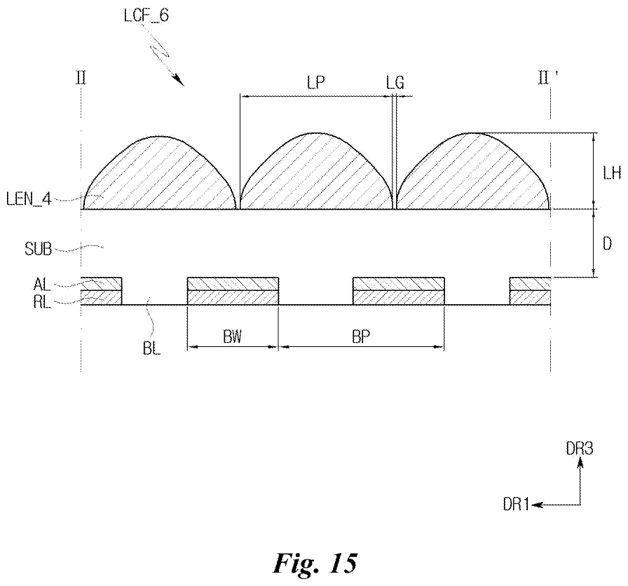

FIG. 16 is a cross-sectional view of a viewing angle control member according to another embodiment.

With reference to FIG. 16, the viewing angle control member LCF_7 according to this embodiment differs from the viewing angle control member LCF of FIG. 4 in that adjacent lens patterns LEN_5 are connected to each other. In this embodiment, the shape is not truncated.

The additional description that has already been made with reference to FIG. 15 will be omitted.

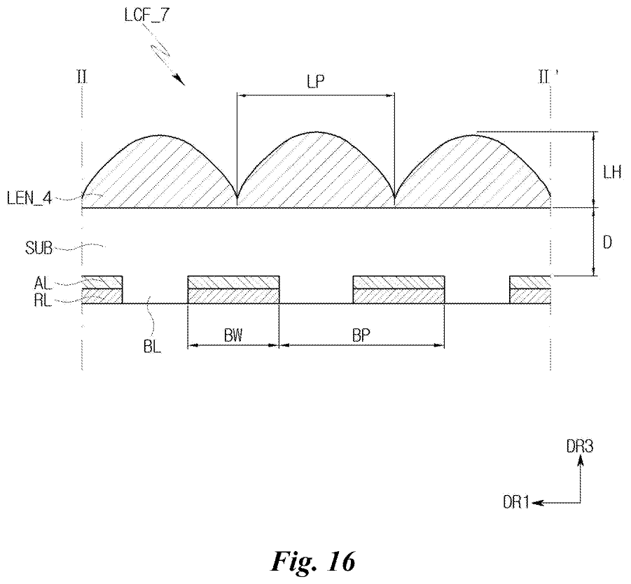

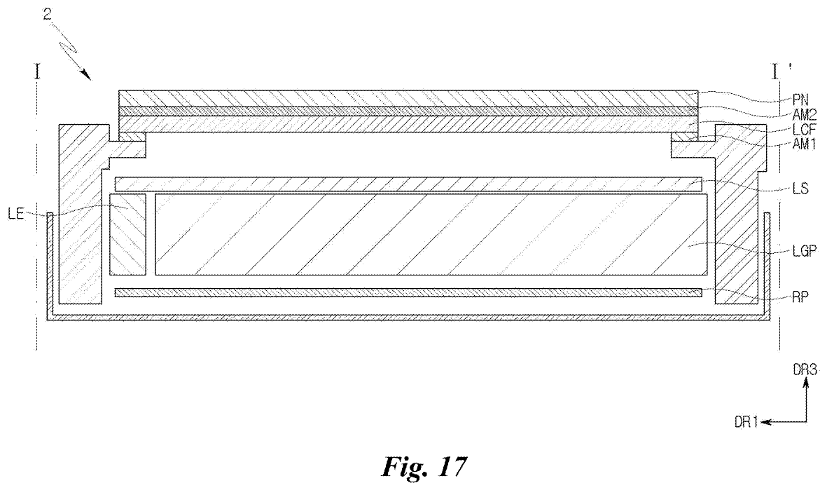

FIG. 17 is a cross-sectional view of a display device according to another embodiment. FIG. 18 is a cross-sectional view of the viewing angle control member and display panel of FIG. 17.

With reference to FIGS. 17 and 18, the display device 2 according to this embodiment differs from the display device 1 of FIG. 2 in that the viewing angle control member LCF may be adhered to the display panel PN via the second adhesive member AM2. The viewing angle control member LCF may be attached to the guide panel GP via the first adhesive member AM1.

As shown in FIG. 18, the second adhesive member AM2 may be directly placed on the lens pattern LEN, and the viewing angle control member (LCF in FIG. 17) and the display panel PN may be adhered through the second adhesive member AM2. Given that the light passing through the viewing angle control member LCF reaches the display panel PN through the second adhesive member AM, in order for the light passing through the lens pattern LEN to be refracted, on the interface between the lens pattern LEN and the second adhesive member (AM2), towards the center of the lens pattern LEN and thus incident onto the display panel PN, it is desirable for the refractive index of the lens pattern LEN to be greater than that of the second adhesive member AM2, preferably with the refractive index difference equal to or greater than about 0.16 between the lens pattern LEN and the second adhesive member AM2.

The additional description that has already been made with reference to FIG. 2 will be omitted.

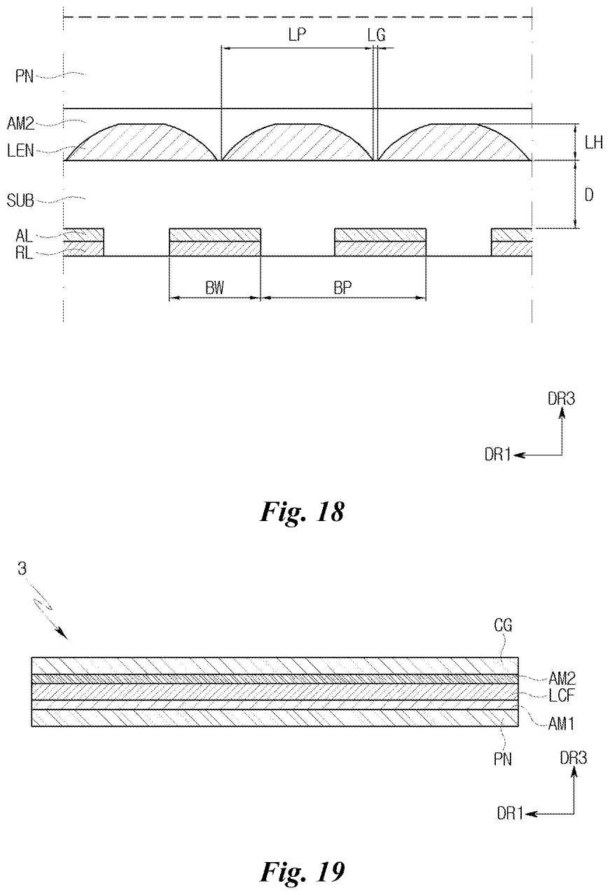

FIG. 19 is a cross-sectional view of a display device according to another embodiment.

With reference to FIG. 19, the display device 3 according to this embodiment differs from the display device 1 of FIG. 2 in that it is an organic light emitting display device. The display device 3 may include a display panel PN, a viewing angle control member LCF on the display panel PN, and a cover member CG on the viewing angle control member LCF. The first adhesive member AM1 may be interposed between the display panel PN and the viewing angle control member LCF, and the second adhesive member AM2 can be interposed between the viewing angle control member LCF and the cover member CG.

The additional description that has already been made with reference to FIG. 2 will be omitted.

Although embodiments of this disclosure have been described above with reference to the accompanying drawings, it will be understood by those skilled in the art that this disclosure can be implemented without departing the technical concept of this disclosure. Therefore, it should be understood that the embodiments described above are exemplary and not limited in all respects.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A viewing angle control member comprising:
a substrate; and
a plurality of lens patterns arranged on the substrate,
wherein the lens patterns have a flat bottom surface, a flat top surface and rounded sidewalls extending in an arc shape from the bottom surface to the top surface.

2. The viewing angle control member of claim 1, further comprising an absorptive layer arranged on a bottom surface of the substrate.

3. The viewing angle control member of claim 2, wherein the absorptive layer has a transmittance of 10% or less for light from the bottom.

4. The viewing angle control member of claim 2, further comprising a reflective layer arranged on a bottom surface of the absorptive layer and overlapping with the absorptive layer, wherein the absorptive layer and the reflective layer constitute a lower layered structure.

5. The viewing angle control member of claim 4, wherein the reflective layer has a specular reflection rate of 20% or more for the light incident from the bottom.

6. The viewing angle control member of claim 4, wherein the lower layered structure is arranged between adjacent lens patterns and provided in plurality.

7. The viewing angle control member of claim 6, wherein the lens patterns have an inclination angle of between 30° to 70°, the sidewalls of the lens patterns has a radius of curvature of 1 mm or less, the lens patterns have a first width and spaced apart from each other by a first separation distance, the lower layered structures has a second width and are arranged with a first pitch, and the sum of the first width and the first separation distance is equal to the first pitch.

8. The viewing angle control member of claim 7, wherein the first width is 0.8 to 1 times the first pitch, the first separation distance is 0 to 0.2 times the first pitch, the lens patterns have a first thickness of 0.005 to 0.5 times of the first pitch, the substrate has a second thickness of 0.7 to 1.3 times the first pitch, and the second width is 0.2 to 0.7 times the first pitch.

9. The viewing angle control member of claim 6, further comprising a lower lens layer arranged between the lower layered structures on the bottom surface of the substrate.

10. The viewing angle control member of claim 9, wherein the lower lens layer is arranged between the lower layered structures and the substrate.

11. The viewing angle control member of claim 1, wherein the lens patterns have a refractive index of 1.4 to 2.0, and the substrate have a refractive index of 1.45 to 1.7.

12. The viewing angle control member of claim 1, wherein the plurality of lens patterns are extended in one direction and arranged in another direction intersecting the one direction.

13. The viewing angle control member of claim 1, wherein the plurality of lens patterns are arranged in an island array.

14. A viewing angle control member comprising:
a substrate;
a plurality of lens patterns arranged on the substrate,
wherein the lens patterns have a generally triangular shape with rounded sidewalls extending from the base of the triangle to the top region.

15. The viewing angle control member of claim 14, further comprising an absorptive layer arranged on a bottom surface of the substrate.

16. The viewing angle control member of claim 15, further comprising a reflective arranged on the bottom surface of the absorptive layer and overlapping with the absorptive layer, wherein the absorptive layer and the reflective layer constitute a lower layered structure.

17. The viewing angle control member of claim 16, wherein the lower layered structure is arranged between adjacent lens patterns and provided in plurality.

18. A display device comprising:
a display panel;
a viewing angle control member arranged beneath a bottom surface of the display panel; and
an adhesive member bonding the display panel and viewing angle control member,
wherein the viewing angle control member comprises:
a substrate; and
a plurality of lens patterns arranged on the substrate and having a refractive index greater than that of the adhesive member.

19. The display device of claim 18, wherein the lens patterns has at least one of a generally trapezoidal shape or a generally triangle shape, each with rounded sidewalls extending from a bottom surface of the lens to a top region of the lens.

20. A display device comprising:
a display panel; and
a viewing angle control member arranged on a top surface of the display panel,
wherein the viewing angle control member comprises:
a substrate; and
a plurality of lens patterns arranged on the substrate and has at least one of a generally trapezoidal shape or a generally triangular shape, each with rounded sidewalls extending from a bottom surface of the lens to a top region of the lens.
